(19) United States
(12) Patent Application Publication
(10) Pub. No.: US 2024/0403060 A1
(43) Pub. Date: Dec. 5, 2024

(54) REBOOTING OR HALTING A HUNG NODE WITHIN CLUSTERED COMPUTER ENVIRONMENT

(71) Applicant: International Business Machines Corporation, Armonk, NY (US)

(72) Inventors: Perinkulam I. GANESH, Round Rock, TX (US); Esdras E. CRUZ-AGUILAR, Round Rock, TX (US); Ravi A. SHANKAR, Austin, TX (US); Brian Frank VEALE, Cedar Park, TX (US); Amanda LIEM, Austin, TX (US); Matthew R. OCHS, Austin, TX (US); Jes Kiran CHITTIGALA, Kukatpally (IN)

(21) Appl. No.: 18/327,670

(22) Filed: Jun. 1, 2023

(51) Int. Cl. G06F 9/4401

(52) U.S. Cl. CPC G06F 9/4401

(57) ABSTRACT

Embodiments of the present disclosure provide systems and methods for rebooting or halting a hung node within a logical partition cluster of a multiple processor computer system. In a disclosed embodiment, a hypervisor maintains a health monitor timer for a logical partition within a logical partition cluster. The hypervisor detects a hung node or logical partition within the logical partition cluster and provides a timely halt or reboot of the hung logical partition to avoid data corruption.

### BACKGROUND

The present invention relates to computer systems, and more specifically, to systems and methods for rebooting or halting a hung node within a logical partition cluster of a multiple processor computer system.

A multiple processor computer system can contain multiple execution contexts called virtual machines or logical partitions (also called LPARs). A group of independent virtual machines or logical partitions may be gathered into one entity by a virtual concept known as a cluster or logical partition cluster. Each virtual machine or logical partition in the logical partition cluster is called a node. The virtual machines or nodes exchange heartbeat messages and control messages amongst themselves over multiple communication interfaces to track the health of each other and to perform coordinated configuration operations. An important purpose of a cluster is to provide high availability. Nodes in a cluster can become hung and unresponsive to heartbeats and control messages. For example, a hung node situation can occur when the node or logical partition has not been scheduled for a while by a hypervisor or the logical partition is processing too many interrupts. The hung node may lack the ability to get out this hung state on its own. For example, a hung node cannot send or receive heartbeats and other control messages. Other nodes within the clustered environment can detect the hung node after the hung node stops sending the heartbeat and control messages and mark the affected node down. When a node is marked down, the workload running on that node can be moved to another healthy node. A timely halt or reboot of the hung node could avoid data corruption.

### SUMMARY

Embodiments of the present disclosure provide systems and methods for rebooting or halting a hung node within a logical partition cluster of a multiple processor computer system.

A disclosed non-limiting computer implemented method comprises maintaining a health monitor timer for a logical partition in a logical partition cluster, the health monitor timer running within a hypervisor associated with the logical partition. The logical partition periodically provides a timer reset to the health monitor timer within the hypervisor. The hypervisor identifies a hung node for the logical partition after a timeout period without receiving the timer reset from the logical partition. The hypervisor resets the logical partition based on a configured tunable command for the logical partition.

Other disclosed embodiments include a computer system and computer program product for rebooting or halting a hung node within a logical partition cluster, implementing features of the above-disclosed method.

### BRIEF DESCRIPTION OF THE DRAWINGS

FIG. 1 is a block diagram of an example computer environment for use in conjunction with one or more embodiments for rebooting or halting a hung node within a logical partition cluster;

FIG. 2 is a block diagram of an example system for rebooting or halting a hung node within a logical partition cluster of one or more disclosed embodiments;

FIG. 3 is a flow chart of example operations of a method for rebooting or halting a hung node within a logical partition cluster of one or more disclosed embodiments;

FIG. 4 is a flow chart of example operations of a method for implementing Live Partition Mobility (LPM) of one or more disclosed embodiments;

FIG. 5 is a flow chart of example operations of a method for implementing Live Kernel Update (LKU)) of one or more disclosed embodiments; and

FIG. 6 is a flow chart of a method for rebooting or halting a hung node within a logical partition cluster of one or more disclosed embodiments.

### DETAILED DESCRIPTION

Embodiments of the present disclosure provide systems and methods for rebooting or halting a hung node within a logical partition cluster of a multiple processor computer system. A logical partition cluster comprises a plurality of independent virtual machines or logical partitions (also called nodes). Embodiments of the present disclosure can detect a hung node and provide a timely halt or reboot of the hung node to avoid data corruption. In a disclosed embodiment, a health monitor timer is maintained for a logical partition in a logical partition cluster. The health monitor timer runs within a hypervisor associated with the logical partition. The logical partition periodically provides a timer reset to the health monitor timer within the hypervisor. The hypervisor identifies a hung node state for the logical partition after a timeout period without receiving the timer reset from the logical partition. The hypervisor resets the logical partition based on a configured tunable command for the logical partition. In one embodiment, the hypervisor identifies a given type of the reset comprising one of a timer disabled reset, a dump enabled reset, a hard restart reset (reboot immediately) or a power off reset.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a Logical Partition Cluster Control Component 182 and a Hypervisor Logical Partition Health Monitor Timer and Command Control Component 184 at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

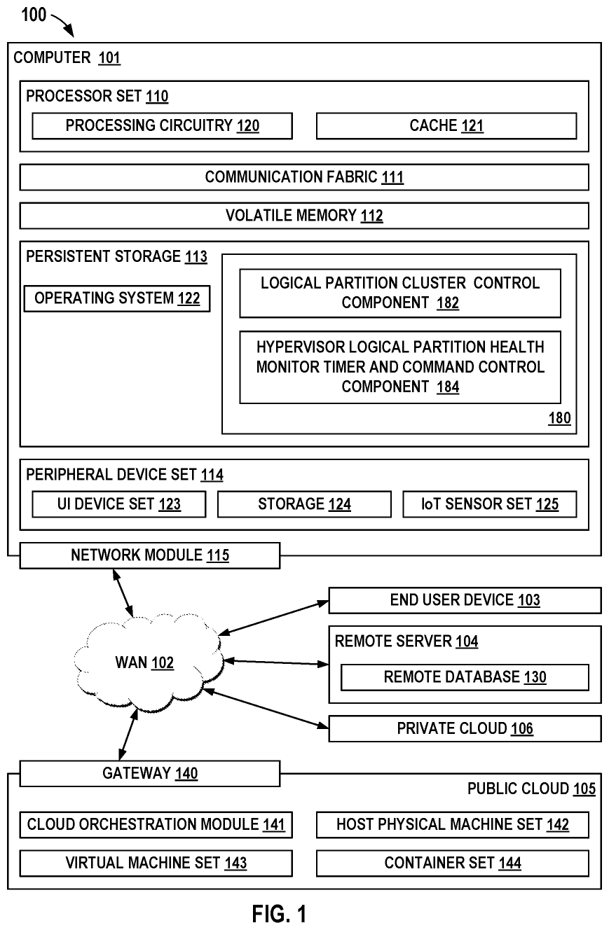

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Embodiments of the present disclosure provide systems and methods for rebooting or halting a hung node within a logical partition cluster of a multiple processor computer system. Embodiments of the present disclosure can detect a hung node within the logical partition cluster and provide a timely halt or reboot of the hung node to avoid data corruption. In a disclosed embodiment, a health monitor timer is maintained for a logical partition in a logical partition cluster. The health monitor timer runs within a hypervisor associated with the logical partition. The logical partition periodically provides a timer reset to the health monitor timer within the hypervisor. The hypervisor identifies a hung logical partition after a timeout period without receiving the timer reset from the logical partition and resets the logical partition based using a hypervisor system call. The hypervisor performs the reset based on a configured tunable command for the logical partition. The hypervisor identifies a given type of the reset comprising one of a timer disabled reset, a dump enabled reset, a hard restart reset (reboot immediately) or a power off reset.

Examples components of an IBM® Power System are used for illustrative purposes in the following description. It should be understood that the disclosed embodiments are not limited by the illustrative examples; the disclosed embodiments can be used with various computer systems.

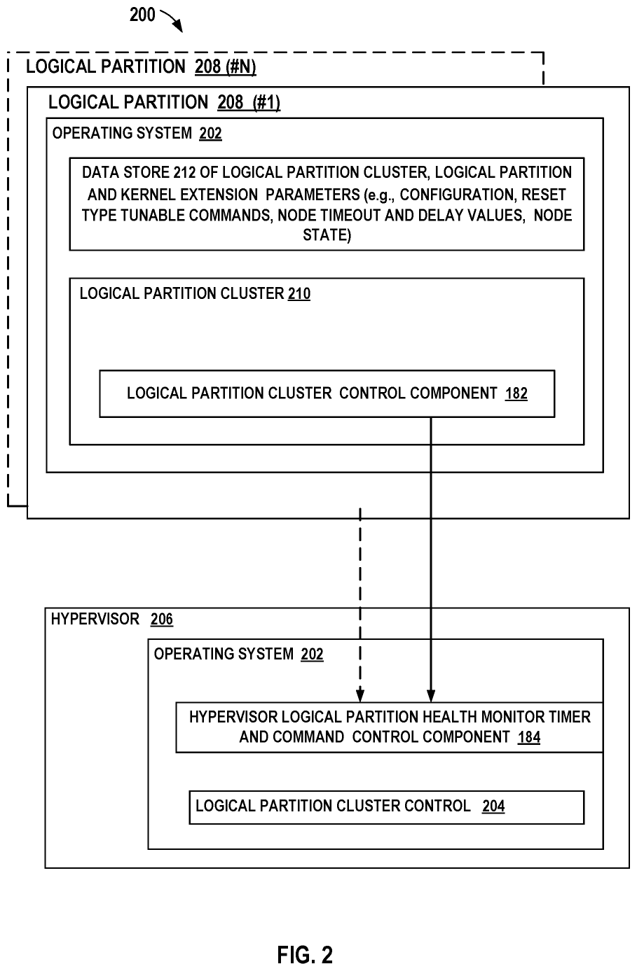

FIG. 2 illustrates a system 200 for rebooting or halting a hung node within a logical partition cluster of a multiple processor computer system of one or more disclosed embodiments. System 200 can be used in conjunction with the Logical Partition Cluster Control Component 182, the Hypervisor Logical Partition Health Monitor Timer and Command Control Component 184, the computer 101 and cloud environment of the computing environment 100 of FIG. 1 for rebooting or halting a hung node within a logical partition cluster of a multiple processor computer system one or more disclosed embodiments.

System 200 includes an Operating System 202, a Logical Partition Cluster Control 204, and at least one Hypervisor 206. System 200 can includes one or a plurality of Logical Partitions 208, and a Logical Partition Cluster 210 of one or a plurality of the Logical Partitions 208 (e.g., the Logical Partitions 208 include one or more logical partition types). The Logical Partition Cluster Control Component 182 is provided within the Operating System 202, (e.g., or operating system 122 of FIG. 1). Each of the Logical Partitions 208, and the Logical Partition Cluster Control 204 include the Operating System 202. System 200 includes a Data Store 212, provided with the Operating System 202. The Data Store 212 for example, stores cluster and kernel extension configuration parameters (e.g., reset type, tunable commands, node timeout and delay values, node state, and the like) for each Logical Partition 208. The Logical Partition Cluster Control 204 allows the Logical Partitions 208 of the Logical Partition Cluster 210 to share physical resources such as central processor units (CPUs), and common available storage devices for example through a storage area network (SAN) or through serial-attached SCSI (SAS) subsystems. System 200 can use such shared storage devices as a cluster repository disk for the Data Store 212 and for other clustered shared disks.

System 200 can use the Logical Partition Cluster Control 204 to monitor communications and network topology changes at various levels for the available services of Logical Partitions 208 within the Logical Partition Cluster 210. Cluster communication can take advantage of traditional networking interfaces, such as IP based network communications and storage interface communication through Fibre Channel and SAS adapters.

In a disclosed embodiment, the Logical Partition Cluster Control 204 uses unicast; and if the nodes or Logical Partitions 208 are within one subsystem, the Logical Partition Cluster Control 204 can use unicast or multicast communications for heartbeats, control and protocol messages between the Logical Partitions 208. The plurality of nodes or Logical Partitions 208 exchange heartbeats, control and protocol messages over multiple communication interfaces to track the health of each other and to perform coordinated configuration operations. Each node or Logical Partition 208 includes at least one address, such as an Internet Protocol (IP) address; which for example is configured on its network interface. For example, the Logical Partition addresses can be used for creating a multicast address for internal cluster communications and multicasting by the Logical Partition Cluster Control 204 and the Logical Partitions 208. The configured nodes or Logical Partitions 208 support cluster monitoring of events and cluster configuration attributes, exchanging heartbeats, control and protocol messages.

A node or Logical Partition 208 can be marked down by other Logical Partitions 208 when a heartbeat message is not received within a combined node_timeout and node_down_delay_timeout interval. For example, the node_timeout can be provided in a range of 10 seconds to 600 seconds. For example, the node_down_delay_timeout can have a range of 5 seconds to 600 seconds. The combined node_timeout and node_down_delay_timeout interval provides a buffer node timeout for the other logical partitions 208 to mark a node down. The Logical Partition Cluster Control 204 can use a default node timeout value that is based on the node timeout value or time interval as a timeout value for a health-monitor timer of the associated Hypervisor 206. The health-monitor timer runs within the Hypervisor 206 associated with the specific Logical Partition 208. The Hypervisor health-monitor timer can be set to guarantee that by the time other nodes or Logical Partitions 208 mark an affected node as down to take over the workload, the affected node or Logical Partitions 208 has relinquished its access from the workload. If the node timeout value is changed then the Logical Partition Cluster Control 204 updates the Hypervisor health-monitor timer to use the new value internally.

System 200 can include Logical Partitions 208 of the Logical Partition Cluster 210 in one or more central electronic complexes (CECs). System 200 can include one Hypervisor 206 associated with one or more respective Logical Partitions 208 within the Logical Partition Cluster 210. For example, one Hypervisor 206 in a first CEC can be associated with one or more respective Logical Partitions 208 in the first CEC, and another Hypervisor 206 in a second CEC can be associated with one or more respective Logical Partitions 208 in the second CEC. In a disclosed embodiment, a respective Hypervisor 206 monitors one or more associated Logical Partitions 208 to identify cluster and kernel extension state and configuration parameter values (e.g., logical partition state of hung state, start state, stop state, and the like) to detect a timeout of its respective associated health monitor timers.

Logical Partition Cluster Control 204 can provide kernel extension services with the respective Logical Partitions 208 that can detect if underlying hardware of a Logical Partition 208 supports a health monitor timer capability of a Hypervisor 206 associated with the Logical Partition. If so, the Logical Partition Cluster Control 204 registers the health monitor timer for the Logical Partition 208 for example, via the kernel services provided for the Logical Partition. When a node or Logical Partition 208 joins a Logical Partition Cluster 210, the Logical Partition Cluster Control 204 starts the timer when the kernel extension services are configured on the node or Logical Partition 208. When a node or Logical Partition 208 is removed from the Logical Partition Cluster 210, the Logical Partition Cluster Control 204 stops and unregisters the health monitor timer. When a node or Logical Partition 208 is in a stopped state, the Logical Partition Cluster Control 204 stops the health monitor timer and restarts the health monitor timer when node or Logical Partition 208 is put back to a start state.

In a disclosed embodiment, the Logical Partition Cluster Control 204 supports rebooting or halting a hung node or hung Logical Partition 208 within the Logical Partition Cluster 210 by an associated Hypervisor 306. System 200 can create a Logical Partition Cluster 210 of a set of nodes (e.g., two or more Logical Partitions 208) in one or more CECs, where the interconnected set of nodes or Logical Partition 208 can leverage the capabilities and services of the Logical Partition Cluster Control 204.

In a disclosed embodiment, the Logical Partition Cluster Control 204 supports creating a Logical Partition Cluster 210 comprising one or more Logical Partitions 208 at different hardware levels, while the Logical Partitions include a common software level (i.e., an identical or the same software level). The Logical Partition Cluster Control 204 supports the functionality to reset or reboot hung nodes at an effective software boundary level, where this functionality can be enabled when all nodes within the cluster include this effective software level.

In a disclosed embodiment, the Logical Partition Cluster Control 204 detects if the underlying hardware of a given Logical Partition 208 can support a health monitor timer capability, and if so the Logical Partition Cluster Control 204 can register, start, stop, and unregister the health monitor timer on the Logical Partition 208 with its associated Hypervisor. It is not necessary for a given Logical Partition 208 to support for the health monitor timer capability. The Logical Partition Cluster Control 204 avoids a limitation that all nodes within a clustered environment must run at the same hardware level. All nodes or Logical Partitions 208 in the Logical Partition Cluster 210 are only required the same software capability, for example to exchange heartbeats, protocol and command messages. The Logical Partition Cluster Control 204 can automatically create a Logical Partition Cluster 210 for example at a required functionality level, when initiated by a system administrator.

System 200 can use the Logical Partition Cluster Control Component 182 with the Hypervisor Logical Partition Health Monitor Timer and Command Control Component 184 and the associated at least one Hypervisor 206 of the respective Logical Partitions 208 within the Logical Partition Cluster 210 to provide a health monitoring timer capability for the Logical Partitions 208. The associated Hypervisor 206 has direct access to the respective Logical Partition 208 and can directly reset and reboot the hung Logical Partition, without using the heartbeat communication resources of the Logical Partition Cluster 210.

A given Logical Partition 208 can be added to a given Logical Partition Cluster 210 and registered with its associated Hypervisor 206 to enable the health-monitor timer of disclosed embodiments. In normal operation, the Logical Partition 208 periodically resets the health-monitor timer applying a health-monitor reset to its associated Hypervisor 206. Failure to reset the health-monitor timer by the Logical Partition 208 results in the associated Hypervisor 206 performing a type of Logical Partition reset, rebooting or halting (e.g., shutting down) the hung Logical Partition 208 directly by the Hypervisor. System 200 enables three types of resets based on configured tunable commands for the hung Logical Partition 208. For example, for the hung Logical Partition 208 can be reset by the Hypervisor 206 based on a configured tunable command including one of: n (timer disabled), d (dump enabled), h (hard restart) or p (power off) by the associated Hypervisor 206. The associated Hypervisor 206 can halt or reboot an affected Logical Partition 208 using the configured tunable command for a given reset type, (e.g., one of timer disabled (n), dump enabled (d), hard restart (h) for immediate reboot, and power off (p) for the Logical Partition.

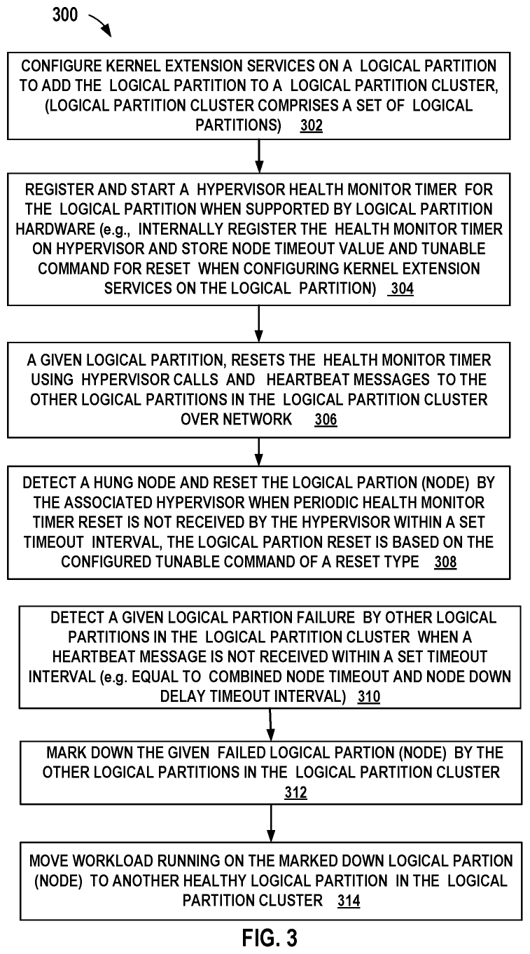

FIG. 3 is a flow chart of example operations of a method 300 for rebooting or halting a hung node within a logical partition cluster of one or more disclosed embodiments. At a block 302, the Logical Partition Cluster Control Component 182 configures kernel extension services on a Logical Partition 208 to add the Logical Partition to a Logical Partition Cluster 210. The Logical Partition Cluster 210 includes multiple (two or more) Logical Partitions 208. The kernel extension provided by the Logical Partition Cluster Control 204 can detect if underlying hardware of the added Logical Partition 208 supports a health monitor timer capability of a Hypervisor 204 associated with the Logical Partition.

At a block 304, the Logical Partition Cluster Control 204 registers the health monitor timer for the Logical Partition 208 for example, via the kernel services provided for the Logical Partition. If the health monitor timer cannot be started, such as due to lack of hardware support, in one embodiment, the failure is ignored and the node or Logical Partition is configured by the Logical Partition Cluster Control 204. At block 304, when the node or Logical Partition 208 joins the Logical Partition Cluster 210, the Logical Partition Cluster Control 204 starts the timer and stores an address, timeout value, and tunable command for reset in the Data Store 212. When a given node or Logical Partition 208 is removed from the Logical Partition Cluster 210, the Logical Partition Cluster Control 204 stops and unregisters the health monitor timer. When a given node or Logical Partition 208 is stopped, the Logical Partition Cluster Control 204 stops the health monitor timer and restarts the health monitor timer when the node or Logical Partition 208 is put back to a start state.

At block 306, a given Logical Partition 208 which has registered with the Hypervisor 306, concurrently resets the health monitor timer using Hypervisor calls and heartbeat messages to other Logical Partitions 208 in the Logical Partition Cluster 210. The Logical Partitions 208 exchange the heartbeat, control, and protocol messages that are used to track the health of each other and to perform coordinated configuration operations.

At block 308, the associated Hypervisor 206 detects a hung node or hung Logical Partition upon failure to receive the health monitor timer reset from the Logical Partition 208. In response the Hypervisor 206 performs a Logical Partition reset, rebooting or halting (e.g., shutting down) the hung Logical Partition 208. For example, a hung Logical Partition 208 including a health monitor timer is reset, rebooted, or halted directly by the Hypervisor 206 before the other Logical Partitions 208 could detect a heartbeat message failure to mark down the hung Logical Partition. That is, the Logical Partition is reset, rebooted, or halted directly by the Hypervisor 206 before other logical partitions could detect missing heartbeat messages from the hung Logical Partition. System 200 enables a configured reset type based on configured tunable commands for the hung Logical Partition 208. For example, the hung Logical Partition 208 can be reset with a health monitor timer disabled, a workload or data dump enabled, a hard restart to immediately reboot the hung Logical Partition 208, and to power off of the Logical Partition.

At block 310, a failure of a given Logic Partition 208 is detected by other Logical Partition 208 in the Logical Partition Cluster 210 when a heartbeat message is not received from the given Logic Partition 208 within a set timeout interval, which for example is equal to a combined node_timeout and node_down_delay_timeout interval. At block 312, the failed given Logical Partition 208 is marked down by the other Logical Partitions 208. For example, when a given Logical Partition 208 has not registered a health monitor timer with the Hypervisor 306, the other Logical Partitions 208 mark down the given Logical Partition after failure to receive a heartbeat message within the combined node_timeout and node_down_delay_timeout interval. At block 314, system 200 moves a workload running on the marked down node or Logical Partition 208 to another healthy Logical Partition in the Logical Partition Cluster 210.

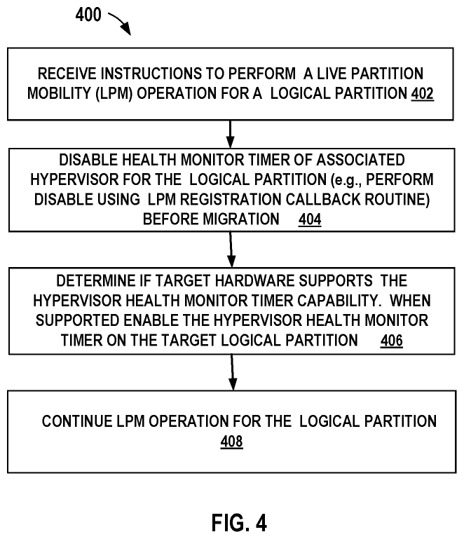

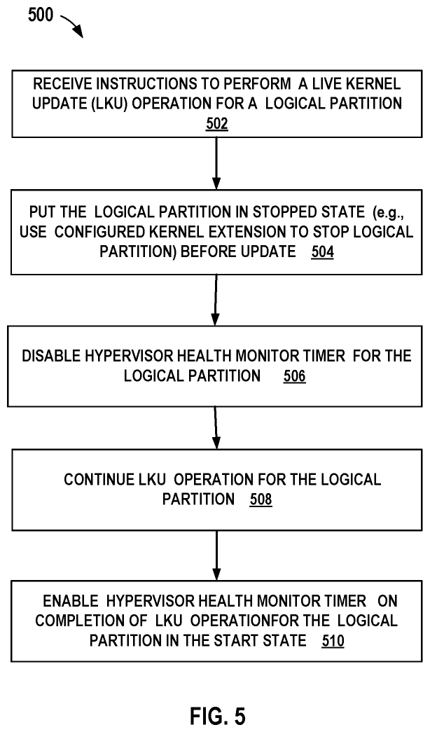

FIGS. 4 and 5 illustrate example operations for implementing Live Partition Mobility (LPM) and Live Kernel Update (LKU) operations. During LPM or LKU operations, it is possible that a given destination CEC for the Logical Partition 208 does not support the capability for the health monitor timer. The Logical Partition Cluster Control 204 does not require the destination or target Logical Partition 208 to support this capability, and permits the LPM) and LKU operations to continue, when the health monitor timer is not supported by the target Logical Partition.

FIG. 4 illustrates example operations of a method 400 for implementing a LPM operation of a given Logical Partition 208 of disclosed embodiments. At block 402, the Logical Partition Cluster Control 204 receives instructions to perform a LPM operation. At block 404 for the LPM operation, the Logical Partition Cluster Control 204 disables the Hypervisor health monitor timer, for example using a LPM registration callback routine, prior to migration. At block 406, the Logical Partition Cluster Control 204 determines if the target hardware of the LPM operation supports the Hypervisor health monitor timer and if so, enables the Hypervisor health monitor timer on the target Logical Partition. If not, the Hypervisor health monitor timer is not enabled. At block 408, the Logical Partition Cluster Control 204 enables the LPM operation to continue.

FIG. 5 illustrates example operations of a method 500 for implementing a LKU operation for a given Logical Partition 208 of disclosed embodiments. At block 502, the Logical Partition Cluster Control 204 receives instructions to perform a LKU operation for the given Logical Partition 208. At block 504 for the LKU operation, the Logical Partition Cluster Control 204 puts the node or Logical Partition 208 in STOPPED state prior to the update. At block 506, with the Logical Partition 208 in STOPPED state, the Logical Partition Cluster Control 204 disables the Hypervisor health monitor timer. At block 508, the Logical Partition Cluster Control 204 enables the LKU operation to continue. At block 510 successful completion of the LKU operation, when possible the Logical Partition Cluster Control 204 restarts the Hypervisor health monitor timer.

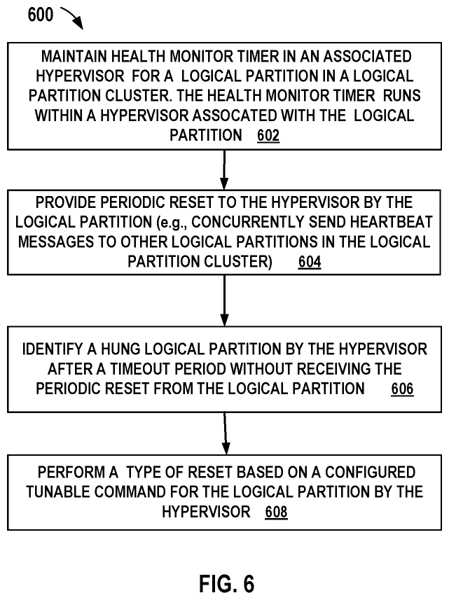

FIG. 6 is a flow chart of a method 600 for rebooting or halting a hung node within a logical partition cluster of one or more disclosed embodiments. At block 602, system 200 maintains a health monitor timer for a logical partition in a logical partition cluster. The health monitor timer runs within a hypervisor associated with the logical partition. At block 604, the logical partition periodically provides a timer reset to the hypervisor to reset the health monitor timer within the hypervisor. For example, the logical partition 208 concurrently sends heartbeat messages to other logical partitions 208 in the logical partition cluster 210. At block 606, the hypervisor identifies a hung node or hung logical partition after a timeout period without receiving the timer reset from the logical partition. At block 606, the hypervisor resets the hung logical partition based on a configured tunable command for the logical partition. For example, the hypervisor performs a hypervisor system call to reset the hung logical partition, such as, with a hard restart to immediately reboot the hung logical partition, or a power off the hung logical partition.

While the foregoing is directed to embodiments of the present invention, other and further embodiments of the invention may be devised without departing from the basic scope thereof, and the scope thereof is determined by the claims that follow.

What is claimed is:

1. A method comprising:
maintaining a health monitor timer for a logical partition in a logical partition cluster, wherein the health monitor timer runs within a hypervisor associated with the logical partition;
periodically sending, from the logical partition to the hypervisor, a timer reset to reset the health monitor timer;
identifying, by the hypervisor, a hung logical partition after a timeout interval without receiving the timer reset from the logical partition; and
resetting the hung logical partition based on a configured tunable command of a reset type.

2. The method of claim 1, wherein resetting the hung logical partition further comprises resetting the hung logical partition with a hard restart to immediately reboot the hung logical partition.

3. The method of claim 1, wherein resetting the hung logical partition further comprises powering off the hung logical partition.

4. The method of claim 1, wherein resetting the hung logical partition further comprises resetting the hung logical partition with at least one of the health monitor timer disabled or dump enabled for the hung logical partition.

5. The method of claim 1, wherein the logical partition cluster comprises a plurality of logical partitions, and further comprises storing, in a data store, cluster and kernel extension configuration parameters for the plurality of logical partitions and the logical partition cluster, where the cluster and kernel extension configuration parameters comprise at least one of tunable commands for a reset type, a node timeout value, a node delay value, or a node state.

6. The method of claim 1, wherein at least one of the configured tunable command of the reset type or the timeout interval for identifying the hung logical partition is stored in a data store of cluster and kernel extension configuration parameters.

7. The method of claim 1, further comprises enabling operations of Live Partition Mobility (LPM) and Live Kernel Update (LKU), and disabling the health monitor timer of the hypervisor associated with the logical partition.

8. The method of claim 1, wherein the logical partition cluster comprises a plurality of logical partitions, and wherein the plurality of logical partitions periodically exchange heartbeat messages to track the health of each other.

9. The method of claim 8, wherein a given logical partition of the plurality of logical partitions is marked down by other logical partitions in the logical partition cluster when a heartbeat message is not received from the given logical partition within a set node timeout interval.

10. The method of claim 1, wherein a workload running on a marked down logical partition is moved to another healthy logical partition in the logical partition cluster.

11. A system, comprising:
a processor; and
a memory, wherein the memory includes a computer program product configured to perform operations for rebooting or halting a hung logical partition within a logical partition cluster, the operations comprising:
maintaining a health monitor timer for a logical partition in a logical partition cluster, wherein the health monitor timer runs within a hypervisor associated with the logical partition;
periodically sending, from the logical partition to the hypervisor, a timer reset to reset the health monitor timer;
identifying, by the hypervisor, a hung logical partition after a timeout interval without receiving the timer reset from the logical partition; and
resetting the hung logical partition based on a configured tunable command of a reset type.

12. The system of claim 11, wherein the hypervisor, resetting the hung logical partition further comprises resetting the hung logical partition with a hard restart to immediately reboot the hung logical partition.

13. The system of claim 11, wherein the logical partition cluster comprises a plurality of logical partitions, and further comprises storing, in a data store, cluster and kernel extension configuration parameters for the plurality of logical partitions and the logical partition cluster, where the cluster and kernel extension configuration parameters comprise at least one of tunable commands for a reset type, a node timeout value, a node delay value, or a node state.

14. The system of claim 11, wherein at least one of the configured tunable command of the reset type or the timeout interval for identifying the hung logical partition is stored in a data store of cluster and kernel extension configuration parameters.

15. The system of claim 11, wherein the logical partition cluster comprises a plurality of logical partitions, and wherein the plurality of logical partitions periodically exchange heartbeat messages to track the health of each other.

16. A computer program product for rebooting or halting a hung logical partition within a logical partition cluster, the computer program product comprising:
a computer-readable storage medium having computer-readable program code embodied therewith, the computer-readable program code executable by one or more computer processors to perform an operation comprising:
maintaining a health monitor timer for a logical partition in a logical partition cluster, wherein the health monitor timer runs within a hypervisor associated with the logical partition;
periodically sending, from the logical partition to the hypervisor, a timer reset to reset the health monitor timer;
identifying, by the hypervisor, a hung logical partition after a timeout interval without receiving the timer reset from the logical partition; and
resetting the hung logical partition based on a configured tunable command of a reset type.

17. The computer program product of claim 16, wherein resetting the hung logical partition further comprises resetting the hung logical partition with a hard restart to immediately reboot the hung logical partition.

18. The computer program product of claim 16, wherein the logical partition cluster comprises a plurality of logical partitions, and further comprises storing, in a data store, cluster and kernel extension configuration parameters for the plurality of logical partitions and the logical partition cluster, where the cluster and kernel extension configuration parameters comprise at least one of tunable commands for a reset type, a node timeout value, a node delay value, or a node state.

19. The computer program product of claim 16, wherein at least one of the configured tunable command of the reset type or the timeout interval for identifying the hung logical partition is stored in a data store of cluster and kernel extension configuration parameters.

20. The computer program product of claim 16, wherein the logical partition cluster comprises a plurality of logical partitions, and wherein the plurality of logical partitions periodically exchange heartbeat messages to track the health of each other.
